(19) United States
(12) Patent Application Publication
(10) Pub. No.: US 2014/0257909 A1
(43) Pub. Date: Sep. 11, 2014

(54) ESTIMATING PROJECT COST

(71) Applicant: INTERNATIONAL BUSINESS MACHINES CORPORATION, Armonk, NY (US)

(72) Inventors: Kelley L. Anders, East New Market, MD (US); Trudy L. Hewitt, Cary, NC (US); James Stetor, Pittsburgh, PA (US)

(73) Assignee: International Business Machines Corporation, Armonk, NY (US)

(21) Appl. No.: 13/793,120

(22) Filed: Mar. 11, 2013

(51) Int. Cl. G06Q 10/06

(52) U.S. Cl. CPC G06Q 10/06313
USPC 705/7.23

(57) ABSTRACT

A method, computer program product, and system is described. One or more project identifiers associated with a project are identified. A secondary data source associated with the project is identified, the identifying based upon, at least in part, identifying an association of the one or more of the project identifiers with the secondary data source. A use of a non-dedicated resource on the project is identified based upon, at least in part, analyzing information from the secondary data source. A cost estimate associated with the project is determined based upon, at least in part, the identified use of the non-dedicated resource on the project.

### TECHNICAL FIELD

This disclosure relates to project management.

### BACKGROUND

In project management, various systems may sometimes be utilized to estimate the costs associated with a particular project. Costs may include, for example, the cost of time devoted to a project by a particular worker or employee, the cost of materials utilized used for a project, outside costs (such as costs associated with vendors and suppliers), and various other resource costs (e.g., the cost of the use of facilities and equipment). In certain projects, certain resources may be designated (at the start of the project and/or at other times) as “dedicated” resources. A dedicated resource may be a resource (e.g., the productive/utilized time of an employee or contractor) that has been directly allocated (wholly or partially) to a particular project. In contrast, a non-dedicated resource may be a resource (e.g., the productive/utilized time of an employee or contractor) that has not been directly allocated to a particular project. In certain instances, a particular resource may be considered as either a dedicated or a non-dedicated resource depending on context and/or other factors. For example, half of an employee's anticipated work time (e.g., 25 hours per week) may be directly allocated to a particular project. As such, for example, for half of the employee's actual work time (e.g., 25 hours per week) the employee (or her work time) may be considered a dedicated resource, whereas for the other half of the employees actual work time (e.g., another 25 hours per week) the employee (or her work time) may be considered a non-dedicated resource.

### BRIEF SUMMARY OF THE DISCLOSURE

According to one aspect of the disclosure, a computer-implemented method includes identifying, by one or more computing devices, one or more project identifiers associated with a project. The method includes identifying, by the one or more computing devices, a secondary data source associated with the project, the identifying based upon, at least in part, identifying an association of the one or more of the project identifiers with the secondary data source. The method includes identifying, by the one or more computing devices, a use of a non-dedicated resource on the project based upon, at least in part, analyzing information from the secondary data source. The method includes determining, by the one or more computing devices, a cost estimate associated with the project based upon, at least in part, the identified use of the non-dedicated resource on the project.

One or more of the following features may be included. Identifying the secondary data source may be based upon, at least in part, one or more of monitoring a communication channel and analyzing a communication item. The secondary data source may include a calendar event. The secondary data source may include presentation material. Analyzing the information from the secondary information source may include determining a time estimate for resource utilization based upon, at least in part, a complexity of the information. Analyzing the information from the secondary data source may include analyzing semantic aspects of the information. The method may include identifying a use of a dedicated resource on the project based upon, at least in part, analyzing information from the secondary data source. The method may include determining an updated cost estimate associated with the project based upon, at least in part, comparing the identified use of the dedicated resource with a prior estimate of use of the dedicated resource.

According to another aspect of the disclosure, a computer program product resides on a computer readable storage medium that has a plurality of instructions stored on it. When executed by a processor, the instructions cause a processor to perform operations including identifying one or more project identifiers associated with a project. The operations include identifying a secondary data source associated with the project, the identifying based upon, at least in part, identifying an association of the one or more of the project identifiers with the secondary data source. The operations include identifying a use of a non-dedicated resource on the project based upon, at least in part, analyzing information from the secondary data source. The operations include determining a cost estimate associated with the project based upon, at least in part, the identified use of the non-dedicated resource on the project.

One or more of the following features may be included. Identifying the secondary data source may be based upon, at least in part, one or more of monitoring a communication channel and analyzing a communication item. The secondary data source may include a calendar event. The secondary data source may include presentation material. Analyzing the information from the secondary information source may include determining a time estimate for resource utilization based upon, at least in part, a complexity of the information. Analyzing the information from the secondary data source may include analyzing semantic aspects of the information. The operations may include identifying a use of a dedicated resource on the project based upon, at least in part, analyzing information from the secondary data source. The operations may include determining an updated cost estimate associated with the project based upon, at least in part, comparing the identified use of the dedicated resource with a prior estimate of use of the dedicated resource.

According to another aspect of the disclosure, a computing system includes one or more processor devices and one or more memory architectures coupled with the one or more processor devices. The one or more processor devices are configured to identify one or more project identifiers associated with a project. The one or more processor devices are configured to identify a secondary data source associated with the project, the identifying based upon, at least in part, identifying an association of the one or more of the project identifiers with the secondary data source. The one or more processor devices are configured to identify a use of a non-dedicated resource on the project based upon, at least in part, analyzing information from the secondary data source. The one or more processor devices are configured to determine a cost estimate associated with the project based upon, at least in part, the identified use of the non-dedicated resource on the project.

One or more of the following features may be included. Identifying the secondary data source may be based upon, at least in part, one or more of monitoring a communication channel and analyzing a communication item. The secondary data source may include a calendar event. The secondary data source may include presentation material. Analyzing the information from the secondary information source may include determining a time estimate for resource utilization based upon, at least in part, a complexity of the information. Analyzing the information from the secondary data source may include analyzing semantic aspects of the information. The one or more processor devices may be configured to identify a use of a dedicated resource on the project based upon, at least in part, analyzing information from the secondary data source. The one or more processor devices may be configured to determine an updated cost estimate associated with the project based upon, at least in part, comparing the identified use of the dedicated resource with a prior estimate of use of the dedicated resource.

According to another aspect of the disclosure, a computer-implemented method includes identifying, by one or more computing devices, one or more project identifiers associated with a project. The method includes identifying, by the one or more computing devices, a secondary data source associated with the project, the identifying based upon, at least in part, identifying an association of the one or more project identifiers with the data source. The method includes identifying, by the one or more computing devices, a use of a dedicated resource on the project based upon, at least in part, analyzing information from the secondary data source. The method includes determining, by the one or more computing devices, an updated cost estimate associated with the project based upon, at least in part, comparing the identified use of the dedicated resource with a prior estimate of use of the dedicated resource.

One or more the following features may be included. Identifying the secondary data source may be based upon, at least in part, one or more of monitoring a communication channel and analyzing a communication item. The secondary data source may include one or more of a calendar event and presentation material. Analyzing the information from the secondary information source may include determining a time estimate for resource utilization based upon, at least in part, a complexity of the information.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a Project Cost Estimation process coupled to a distributed computing network;

FIG. 2 is a flowchart of a process executed by the Project Cost Estimation process of FIG. 1;

FIG. 3 is a diagrammatic view of an aspect of the Project Cost Estimation process of FIG. 1.

Like reference symbols in the various drawings indicate like elements.

### DETAILED DESCRIPTION OF THE PREFERRED EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Various systems (e.g., tools or functionality associated with a Project Management application or process) may estimate and track costs associated with particular projects. In certain instances, these estimates may be based mainly on specified or “dedicated” resources (e.g., specified personnel) who are recognized as contributing to the project (and, therefore, to the project cost). For example, when initiating (and/or updating) a project in a Project Management application, an administrator may indicate that certain employees have been designated as dedicated resources (in whole or in part) with respect to that project. As such, for example, project cost (or a portion thereof) may be estimated (e.g., by the Project Management application) based upon an estimate of the amount of time each dedicated resource is expected to devote to the project and the respective costs of those resources time.

Various other “non-dedicated” resources (e.g., personnel who have not been designated as being assigned—in whole or in part—to a project) may not be recognized by a Project Management application (or, for example, another application or process utilized to estimate project cost) as contributing to a project. In practice, however, such non-dedicated resources may sometimes be utilized on a project to varying degrees. For example, an employee who has not been designated as a dedicated resource for a project may nevertheless spend 10-15 hours a week for several months providing useful support for the project. Accordingly, an estimate of project cost that does not account for this non-dedicated resource contribution (e.g., because a Project Management application calculates a resource cost estimate based primarily on the use of dedicated resources) may not be as accurate as may be desired.

Similarly, in certain instances various dedicate resources may not be utilized for a project to the extent expected or estimated (e.g., because an employee who has been designated as a full-time dedicated resource actually works on the project for only a fraction of her total time). As such, a project cost estimate that assumes full utilization of such devoted resources may not be as accurate as desired.

Accordingly, it may be useful to provide a process or system that accounts for these and other subtleties in the use of dedicated and non-dedicated resources when determining an estimate of costs for a particular project. A Project Cost Estimation (“PCE”) process (or application) may provide this and/or various other functionality. For example, a PCE process may monitor various information sources, such as documents, communications, and so on in order to identify information relevant to a particular project. A PCE process may then analyze such identified information in order to identify utilization (and/or non-utilization) of various dedicated and/or non-dedicated resources on the project, and may determine an estimate of costs relevant to the project based upon such identified utilization (and/or non-utilization) of resources.

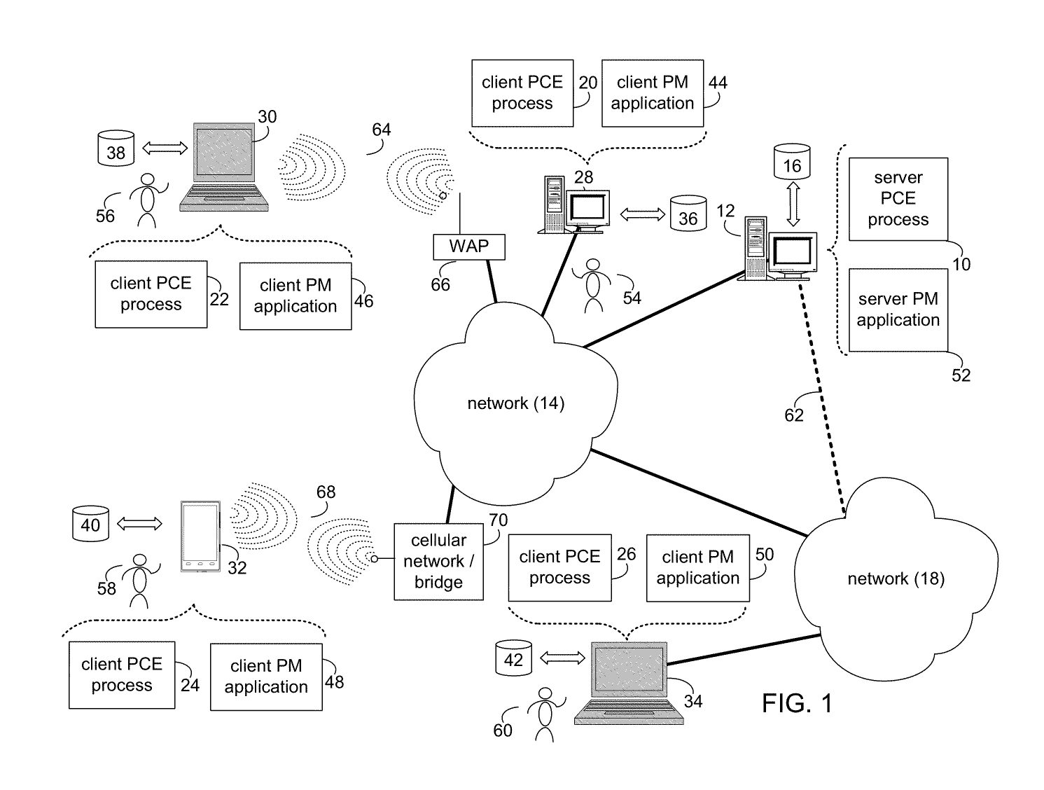

Referring now to FIG. 1, a PCE process may be coupled to a computer or computer network. For example, server PCE process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server®; Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server PCE process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client PCE processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CE®, Red Hat® Linux®, or a custom operating system.

The instruction sets and subroutines of client PCE processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

In an embodiment, the PCE process may be a server-side process (e.g., which may be implemented via server PCE process 10), in which all of the functionality of the PCE process may be executed on a server computer (e.g., server computer 12). In an embodiment, the PCE process may be a client-side process (e.g., which may be implemented via one or more of client PCE processes 20, 22, 24, 26), in which all of the functionality of the PCE process may be executed on a client computing device (e.g., one or more of client electronic devices 28, 30, 32, 34). In an embodiment, the PCE process may be a hybrid server-client process (e.g., which may be implemented by server PCE process 10 and one or more of client PCE processes 20, 22, 24, 26), in which at least a portion of the functionality of the PCE process may be implemented via server computer 12 and at least a portion of the functionality of the PCE process may be implemented via one or more client computing devices (e.g., one or more of client electronic devices 28, 30, 32, 34).

In certain embodiments, a PCE process may be a stand-alone process. In certain embodiments, a PCE process may operate as part of, or in conjunction with, one or more other processes and/or may include one or more other processes. For example, in certain embodiments, a PCE process may be included in (or may operate in conjunction with) a Project Management (“PM”) application (or process), which may facilitate various project management tasks and functionality including, for example, estimation of various costs associated with a project (e.g., total resource costs). Project management, including as facilitated by a project management application, may include management of various aspects of a project, financial/cost management, resource management, and other administrative, financial, and/or technical tasks and functionality.

A PM application (or process) may operate (and/or reside) on a client device (e.g., client PM application 44, operating on client electronic device 28; client application PM 46, operating on client electronic device 30; client PM application 48, operating on client electronic device 32; or client PM application 50, operating on client electronic device 34). A client PCE process (e.g., client PCE process 20) or a server PCE process (e.g., server PCE process 10) may be in communication with a client PM application (e.g., client PM application 44) or may be part of a client PM application.

A PM application may additionally/alternatively operate (and/or reside) on a server device (e.g., server PM application 52, operating on server computer 12 or another server PM application (not shown), operating on another server computer (not shown)). A server PCE process (e.g., server PCE process 10) or a client PCE process (e.g., client PCE process 20) may be in communication with a server PM application (e.g., server PM application 52) or may be a part of a server PM application.

Users 54, 56, 58, 60 may access a PCE process in various ways. For example, these users may access server PCE process 10 directly through the device on which a client process (e.g., client PCE processes 20, 22, 24, 26) is executed, namely client electronic devices 28, 30, 32, 34. Users 54, 56, 58, 60 may access server PCE process 10 directly through network 14 and/or through secondary network 18. Further, server computer 12 (i.e., the computer that executes server PCE process 10) may be connected to network 14 through secondary network 18, as illustrated with phantom link line 62. Users 54, 56, 58, 60 may also access a client or server PM application (or process) in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 64 established between laptop computer 30 and wireless access point (“WAP”) 66, which is shown directly coupled to network 14. WAP 66 may be, for example, an IEEE 802.11a, 802.11b, 802.11g, 802.11n, Wi-Fi, and/or Bluetooth device that is capable of establishing wireless communication channel 64 between laptop computer 30 and WAP 66. Data-enabled mobile telephone 32 is shown wirelessly coupled to network 14 via wireless communication channel 68 established between data-enabled mobile telephone 32 and cellular network/bridge 70, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client PCE process 20 will be described for illustrative purposes. It will be understood that client PCE process 20 may, for example, interact and/or communicate with a server PCE process such as server PCE process 10 and/or may be executed within one or more applications that allow for communication with other server and/or client PCE processes. This is not intended to be a limitation of this disclosure, as other configurations are possible (e.g., PCE process 20 may include stand-alone client processes and/or stand-alone server processes). For example, some implementations may include one or more of client PCE processes 22, 24, 26 or server PCE process 10 in place of or in addition to client PCE process 20.

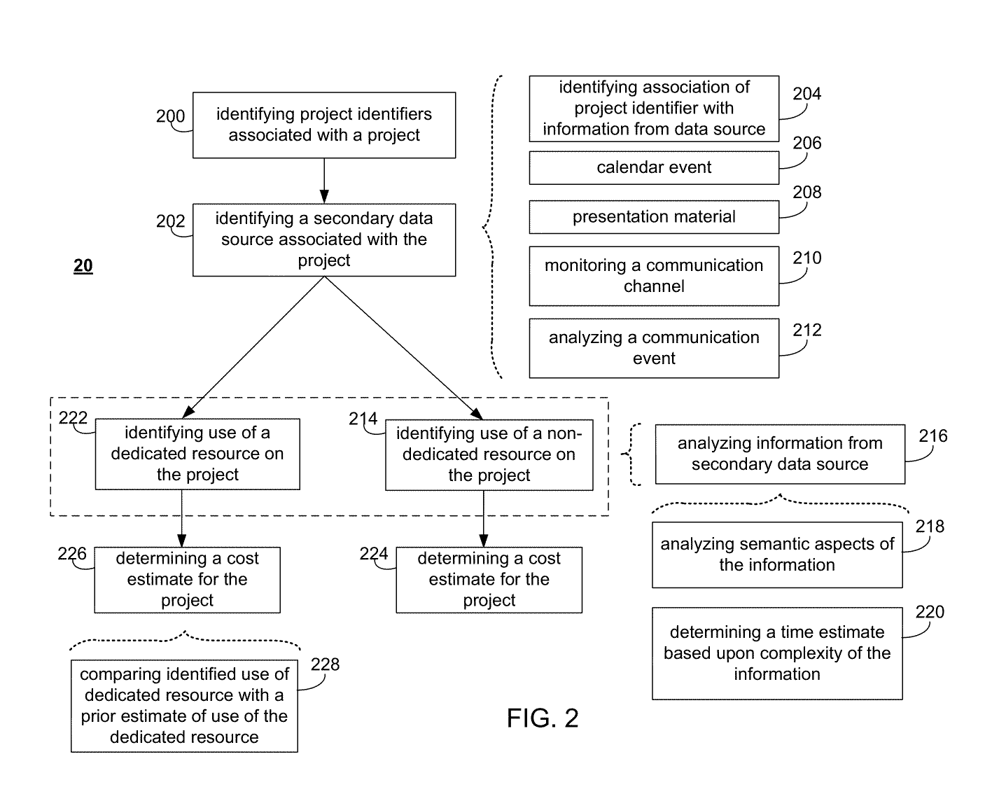

Referring now also to FIG. 2, there is shown a diagrammatic view of an example process that may be implemented by a PCE process, e.g., client PCE process 20. Client PCE process 20 may identify 200 one or more project identifiers associated with a project. A project identifier may be a keyword, a key term, a phrase, an acronym, a code word or phrase or other indicator which may be associated with and/or may be utilized to identify a particular project. For example, in certain embodiments a project identifier may be a code name utilized in internal and/or external company communications to indicate a particular project. In certain embodiments a project identifier may be a non-text identifier, such as a sound or image. It will be understood that, in certain embodiments, a particular project may be associated with multiple project identifiers. For example, a particular project may be associated with project identifiers including a project code-name, various key words associated with the type of work that may be included in the project, one or more images associated with a project logo or other aspect of the project, and so on. In certain embodiments, a particular project identifier may be associated with a number of projects. For example, an identifier associated with a division to which a project may be assigned, in whole or in part, (e.g., “Blue Sky Research Division,” “Product Commercialization” and so on) may be considered as identifying one or more projects associated with that particular division. In certain embodiments, a particular project identifier may be associated with only one project (i.e., one or more project identifiers may be utilized to uniquely identify a particular project). For example, a code name for a project may be associated only with the project to which it refers.

Project identifiers may be associated with one or more projects in a variety of ways. In certain embodiments, for example, when an administrator creates (and/or edits) a project and associated parameters, the administrator may input one or more identifiers to be associated with the project. In certain embodiments, a PM application may facilitate this input (and/or other association of a project identifier with a particular project). For example, a PM application may include functionality that may request and/or receive input regarding project identifiers from an individual who is utilizing the PM application with respect to a particular project. For example, when an administrator creates a project and/or edits project parameters in a PM application, the PM application may prompt the administrator to input one or more project identifiers associated with the project. In certain embodiments, certain project identifiers may be associated with a particular project automatically (e.g., based upon PM application logic or functionality).

PCE process 20 may identify 200 project identifiers in a number of ways. For example, one or more project identifiers (and/or associated information) may be stored in a data repository (e.g., storage device 36) associated with a PM application (e.g., PM application 44) and/or a particular project. Accordingly, for example, PCE process 20 may identify 200 project identifiers associated with that particular project based on a request for information from a PM application (e.g., PM application 44) and/or an associated storage device (e.g., storage device 36).

PCE process 20 may identify 202 a secondary data source associated with the project. A “secondary” data source may be a data source that does not directly include an explicit entry of the time during which a particular resource has been (or will be, or is being) devoted to a particular project (e.g., a time-sheet indicating “Resource: XYZ; Project: ABC; Time: 4 hours on Apr. 4, 2012), but which may contain various other information regarding a project and/or devotion of resources thereto. In certain embodiments, for example, a secondary data source may include a calendar event 206. As used herein, a calendar “event” may include a scheduled meeting, a calendar annotation, a block of time, requested and/or confirmed participants in a meeting, and so on. In certain embodiments, a secondary data source may include presentation material 208 or other documents. Presentation material 208 may include, for example, a slide show presentation, presentation handouts, related attachments, related multi-media materials, and so on. Similarly, for example, a secondary data source may include: a scope of work document; a benchmark or other update; experimentation plans or results; transcripts of electronic or other communication such as telephone conversations, text-based communication (e.g., instant messaging transcripts, transcripts of recorded meetings, and so on), video communications and so on; electronic team room interactions or documents; and/or various other sources of data. In certain embodiments, a secondary data source may include various communication data, such as data including or included in emails, voice communications, text messages, and so on. A secondary data source may be stored in a variety of formats and/or in a variety of locations, including local storage devices, remote and/or cloud-based storage systems, and so on.

PCE process 20 may identify 202 a secondary data source in a variety of ways. For example, PCE process 20 may identify 202 a secondary data source associated with a project based upon, for example, identifying 204 an association of the one or more identified 200 project identifiers with the secondary data source. For example, an email, calendar entry, experiment plan or result, and so on, may often include one or more project identifiers when the contents of these data sources are associated with, or pertain to, a particular project. For example, an email relating to a particular project may include a code name for the project in the subject line, may be addressed to various members of a project team (and/or an email group associated with a particular project), may include various other project identifiers in the body of the mail and/or an attachment, and so on. Similarly, for example, a calendar entry, presentation materials, and so on may include, in various and/or numerous ways, various and/or numerous project identifiers, which may indicate that the calendar entry, presentation materials, and so on may be associated (in whole or in part) with a particular project. Accordingly, for example, based upon identifying 200 that one or more project identifiers associated with a project are included in, referenced by, and/or otherwise associated with a particular secondary data source, PCE process 20 may identify 202 that the particular secondary data source may be relevant to the project.

PCE process 20 may identify 204 an association of relevant project identifiers with a particular secondary data source in a variety of ways. In certain embodiments, for example, PCE process 20 may identify 202 an appropriate secondary data source based upon monitoring 210 a communication channel (e.g., an electronic channel facilitating communication between individuals) and/or analyzing 212 a communication item (e.g., an email, a transcript or other record of a telephone or video call, a transcript of a chat session, the transmission of an attachment, and so on). For example, PCE process 20 may monitor 210 one or more communication channels, such as voice communication channels, email communication channels, text-based chat channels, and/or various other communication channels in order to identify 204 various project identifiers that may be relevant to a particular project and that may be associated with one or more secondary data sources. Such monitoring may include analysis (e.g., by an external application) of the content and/or context of voice communications (e.g., by conversion of voice to text, using various known means), analysis of the content and/or context of text communications, and/or various other analyses. In certain embodiments, a monitoring engine may passively monitor a communication channel (e.g., various internal telephone links) and may accordingly identify 204 (e.g., via voice recognition analysis) the use of various project identifiers in various communications. Such use may indicate, for example, that the various communications in the subject communication channel may be relevant to a particular project.

Similarly, for example, PCE process 20 may analyze 212 a particular communication item, such as a particular telephone call, a particular email, a particular calendar entry, and so on, in order to identify 204 various project identifiers that may be relevant to a particular project and that may be associated with one or more secondary data sources. For example, PCE process 20 may analyze 212 a particular email, telephone call (or transcript thereof), chat session, and so on, and may accordingly identify 204 the use of various project identifiers in a particular communication item. Such use may indicate, for example, that the subject communication item may be relevant to a particular project.

Similarly, PCE process 20 may monitor and/or analyze various other secondary data sources, channels, repositories, and so on, in order to identify 202 secondary data sources that may be associated with a particular project (e.g., based upon identifying 204 association of relevant project identifiers with the various secondary data sources). For example, PCE process 20 may analyze various files associated with a scheduled meeting or presentation, which may, for example, be stored on a data repository accessible via a company intranet architecture. Such files may be determined to be relevant secondary data sources, for example, based upon identification 204 of relevant project identifiers within such files and/or in associated data sources (e.g., calendar events associated with the files). For example, upon scheduling an electronic meeting an administrator (and/or various other users) may upload proposed presentation materials to a central repository. PCE process 20 may analyze those materials (and/or various associated information sources, such as a calendar invite or electronic flier associated with the electronic meeting) in order to identify 204 association of relevant project identifiers with one or more of those files and, accordingly, to identify 202 such files (and/or various associated information sources) as relevant secondary data sources.

PCE process 20 may identify 214 use of a non-dedicated resource on a project (and/or various details associated therewith) based upon, at least in part, analyzing 216 information from identified 202 secondary data sources. For example, PCE process 20 may analyze the context, content, and/or various other aspects of identified 202 secondary data sources in order to determine whether such data sources may indicate the use of various resources (whether dedicated or non-dedicated) on one or more projects.

For example, PCE process 20 may identify that an individual has sent an email to various recipients. PCE process 20 may further, for example, identify 204, based upon the inclusion of various project identifiers in the email text (and/or subject line, attachments, and so on), that the email appears to be associated with the particular project. PCE process 20 may further, for example, identify that although the recipients may all be members of a particular project team (and, for example, may have been designated via PM application 44 as dedicated resources for the project), the individual who sent the email has not been designated as a dedicated resource (i.e., is a non-dedicated resource) with respect to that project (e.g., as determined based upon information from PM application 44). As such, PCE process 20 may identify 214 that the non-dedicated individual has spent some amount of time working on the project.

PCE process 20 may identify 214 the above-described utilization of the non-dedicated resource (i.e., the individual who sent the email) and various related details in various ways. For example, PCE process 20 may identify 214 that the non-dedicated individual has devoted time to the project simply by virtue of composing the email (and/or various attachments or related documents). Additionally/alternatively, based for example on analysis of the content and/or context of the email, PCE process 20 may identify 214 that the non-dedicated individual has devoted time to the project via a related task. For example, analysis 218 of various semantic and/or syntactical information in the email may indicate that the email is a status update for a research project undertaken by the non-dedicated individual. Accordingly, PCE process 20 may identify 214 the utilization of the non-dedicated individual not only with respect to the composition of the email but also with respect to the research project regarding which the email was written.

It will be understood that the discussion above provides only a handful of examples regarding the identification 214 of the use of a non-dedicated resource on a project. For example, utilization of non-dedicated resource, such as an individual, may be identified 214 based upon the individual composing or editing a document or other file, reading a document or other file, viewing a webpage, signing into or otherwise spending time in a team room, accepting a meeting invitation, participating in a communication item, and so on.

It will be further understood that a non-dedicated resource may be utilized with respect to a project in a variety of ways. For example, an individual who has been identified as a non-dedicated resource for a particular project may contribute time to the project by drafting, reading, editing, or otherwise contributing to various documents (including, for example, communication documents, such as emails), by participating in various communications relevant to the project (e.g., email exchanges, telephone calls, text message sessions, and so on), by participating in meetings relevant to the project (e.g., online meetings, in-person meetings, and so on), and so on. As such, for example, PCE process 20 may identify the authorship of various documents and/or communications, participation in a meeting associated with a particular calendar event 206, viewing and/or editing of various documents and/or communications, and various other activities, through which one or more individuals (or other resources) who have been identified as non-dedicated resources for a particular project may be identified 214 as having devoted time (and/or other resources) to the particular project.

As also noted above, PCE process 20 may identify 214, in a variety of ways, various details regarding the use of a non-dedicated resource on a project. For example, having identified 204 the association of a project identifier with information from a secondary data source, PCE process 20 may analyze 216 the secondary data source in order to estimate the amount of time during which a particular non-dedicated resource has been devoted to a particular project (and/or another cost indicator relating to the identified 202 secondary data source). For example, a parsing engine (and/or other module, application or system) may analyze information included in (and/or otherwise associated with) a secondary data source in order to estimate the amount of time during which the relevant non-dedicated resource has been utilized for the particular project (with respect, for example, to a task associated with the secondary data source).

In certain embodiments, PCE process 20 may analyze 218 various semantic aspects of information from the secondary data source in order to determine 220, for example, an amount of time (or an estimate thereof) during which a non-dedicated resource has been utilized for a project. For example, PCE process 20 may determine 220 a time estimate for the use of a non-dedicated resource based upon analyzing 218 the complexity of the information included in a secondary data source (e.g., the size/length of the information, the level of detail or refinement associated with the information, and so on). For example, if a secondary data source includes an email communication composed by an individual who has been identified as a non-dedicated resource, PCE process 20 may analyze 218 the length of the email, the format and formatting of the email, the inclusion of graphics, attachments or other information, the detail of the included discussion, the length of an associated email chain, and so on, in order to determine 220 an approximate amount of time the non-dedicated individual is likely to have devoted to creating the communication (i.e., the amount of time the individual may have spent working on the project, by composing the email). Such analysis may be informed, for example, based upon analysis of historical data (e.g., through data mining of historical secondary data source), various rule-based systems, various expert systems, and various other techniques.

PCE process 20 may similarly analyze 218, for example, secondary data sources with respect to non-authorship activities of a non-dedicated individual. For example, analysis 216, 218 of secondary data sources may facilitate estimating the amount of time (and/or devotion other resources, such as equipment, facilities, and so on) that a non-dedicated individual (and/or other resource) may have spent reading, viewing or editing a document or communication, participating in a project-related meeting or other discussion, and so on.

Continuing the discussion above, for example, a vice president may participate in a weekly update meeting regarding a particular project (as indicated, for example, based upon various information associated with a calendar entry 206 for the meeting). Based upon, for example, having identified that the vice president accepted an invitation to the meeting, that the meeting concerns the particular project, and that the meeting was scheduled for a half an hour of time, PCE process 20 may identify 214 that the vice president has spent half an hour of time on the project. Further, for example, if analysis 216 of relevant secondary data source information indicates that the vice president may have spent additional time on the project (e.g., if PCE process 20 has identified 202 an email to the vice president regarding the meeting that includes a lengthy attachment on the project), PCE process 20 may identify 214 that the vice president has devoted even more time to the project (e.g., an amount of time appropriate to the analysis, at an executive level, of the attachment).

It will be understood that in certain instances, a particular document, communication, meeting, and so on, may be associated with multiple projects. Accordingly, in certain embodiments, PCE process 20 may analyze 216 relevant information in order to allocate an appropriate portion of the utilized of resources that may be associated with such a document, communication, meeting, and so on to the appropriate project. For example, if an individual who has been identified as a non-dedicated resource is determined to have spent 2 hours reading, composing, or otherwise interacting with a particular document, and semantic analysis 218 of the document indicates that it is approximately 50% devoted to project A and 50% devoted to project B (for both of which the relevant individual may be a non-dedicated resource), PCE process 20 may determine 220 that the individual may have spent approximately 1 hour working on project A and approximately 1 hour working on project B. (It will be understood that more nuanced assessments may also be made. For example, if the individual is determined to have spent 1 hour and 45 minutes looking at (or otherwise interacting with) pages of the document associated with project A and only 15 minutes looking at pages of the document associated with project B, an appropriate estimate of devotion of non-dedicated resources may be determined 220 accordingly. Similarly, for example, if semantic analysis 218 suggests that the portions of a document or communication that are associated with project A are significantly more complex than those associated with project B, PCE process 20 may determine 220 that an individual who has authored/read/reviewed the document may have devoted more time to project A than to project B.)

Similarly, continuing the discussion above, if the half-hour meeting the vice president is attending is associated with three different projects (e.g., as determined based upon analysis 216 of an associated calendar entry), PCE process 20 may identify 214 that the vice president has devoted 10 minutes to each of the projects. In certain embodiments, such allocation of the meeting time among projects may be further refined, for example, based upon various analyses 216 of relevant secondary data sources (e.g., as also discussed above).

In addition/as an alternative to identifying 214 the utilization of a non-dedicated resource on a project, PCE process 20 may identify 222 the use of a dedicated resource on a project. PCE process 20 may identify 222 the use of a dedicated resource on a project in a generally similar manner as PCE process 20 may identify 214 the use of a non-dedicated resource, as also discussed herein. For example, PCE process 20 may identify 222 the utilization of a dedicated resource on a project based upon, at least in part, analyzing 216 information from a secondary data source, analyzing 218 various semantic (and/or other) aspects of information associated with such a secondary data source (e.g., complexity of the information) and so on.

Having identified 214, 222, respectively, the use of non-dedicated and/or dedicated resources on a project, PCE process 20 may determine 224, 226 a cost estimate for the project. Because, for example, a determined 224, 226 cost estimate may more accurately reflect utilization of dedicated and/or non-dedicated resources than various prior cost estimates (i.e., based upon the identification 214, 222 of the utilization of non-dedicated and dedicated resources, respectively), it may accordingly represent, in certain embodiments, a more accurate and/or useful estimate of actual (and/or projected) total project costs. For example, based upon identifying 214 use of various non-dedicated resources on a project, PCE process 20 may supplement a prior estimate of project cost which may, for example, have accounted only for the use of dedicated resources and/or previously-identified use of non-dedicated resources. For example, an earlier estimate of project cost (e.g., an estimate associated with a PM application) may have been based upon the projected use of various dedicated resources for the project. As also noted above, however, in certain instances various non-dedicated resources may also be utilized on the project, which use may not have been included in the original cost estimate (e.g., because the estimate addressed only dedicated resources, only particular and/or limited non-dedicated resources, and so on). Accordingly, if PCE process 20 has identified 214 the use of various non-dedicated resources that was not included in a previous cost estimate, it may be useful to update the previous cost estimate to reflect this use. For example, PCE process 20 may have determined 220 that a non-dedicated individual spent approximately 20 hours over the course of a month in drafting and reviewing project-related documents and/or participating in project-related communications, meetings and so on. As such, PCE process 20 (e.g., alone and/or in conjunction with PM application 44) may determine 224 an updated cost estimate for the project that may include the cost of the time (and/or other resources) utilized by the non-dedicated individual with respect to the project.

Similarly, for example, PCE process 20 may have identified 222 a use of a dedicated resource that is not in keeping with a previously determined estimate of project cost associated with that resource. For example, PCE process 20 may have identified that a dedicated individual is spending 20 hours a week on work unrelated to the relevant project (and/or is devoting 20 hours a week to the project in excess of those originally estimated). Accordingly, PCE process 20 may determine 226 an updated estimate of project cost that reflects the deficit (and/or excess) of devotion of time (and/or other resources) by the dedicated individual to the project. For example, based upon identifying 222 that an individual dedicated to Project A is spending 20 hours a week working on a Project B, PCE process 20 may (assuming that the individual works only 40 hours a week) reduce the weekly cost estimate associated with Project A by the value of 20 hours of the individual's work (and may, as appropriate, increase the weekly cost estimate associated with Project B by a similar amount).

In certain embodiments, PCE process 20 may determine 224, 226 a project estimate that is retrospective. For example, PCE process 20 may determine 224, 226 an estimate of cost-to-date for a particular project based upon identifying 214, 222 the past use of various non-dedicated and dedicated resources on the project (e.g., based on past authorship of documents, past participation in project meetings, and so on). In certain embodiments, PPCE process 20 may determine 224, 226 a project estimate that is prospective. For example, PCE process 20 may determine 224, 226 an estimate of future (and/or total) costs for a particular project based upon identifying 214, 222 the projected future use of various non-dedicated and dedicated resources on the project.

A projected future cost may be estimated 224, 226, for example, based upon analyzing 216 calendar events 206 relating to future meetings, otherwise analyzing 216 secondary data sources to identify potential future work (e.g., analyzing 216, 218 an email directing a non-dedicated individual to spend the next week working on a particular element of a particular project), and/or extrapolating various patterns of resource utilization. For example, if PCE process 20 has identified 214 the consistent use of a non-dedicated resource for a certain number of weeks, PCE process 20 may determine 224 a cost estimate for a project that projects similar use of the non-dedicated resource into the future. For example, if a non-dedicated individual has been identified 214 as spending 15 hours per week on a project for the past 8 weeks, PCE process 20 may determine 224 a future cost estimate for the project that assumes similar continued utilization of the non-dedicated individual for future weeks. Similarly, if a dedicated individual has been identified 222 as spending, for the past 5 weeks, 15 hours less per week on a project than was anticipated in a previously calculated cost estimate, PCE process 20 may determine 226 a future cost estimate for the project that assumes similar continued under-utilization of the dedicated individual for future weeks.

Continuing the discussion above, PCE process 20 may, for example, determine 226 a cost estimate for a project based upon comparing 228 the identified 222 use of a dedicated resource with a prior estimate of use of the dedicated resource. For example, prior cost estimates for a particular project may have assumed that a particular (dedicated) individual would devote all of his working time to the project. PCE process 20 may have identified 216, however, that the individual is actually devoting part of his time to a different project, and is accordingly devoting less time to the original project than was originally estimated (or, alternatively, is devoting significant over-time to the project and, accordingly, is devoting more time than was originally estimated). Accordingly, PCE process 20 may determine 226 an updated costs estimate for the project based upon the identified 222 partial (or over-) utilization of the dedicated individual's time.

Similarly, in certain embodiments, assessing the utilization of non-dedicated (and/or dedicated) resources may also support periodic evaluation of whether a resource should actually be considered non-dedicated (and/or dedicated). For example, if a particular non-dedicated resource is being utilized to its full extent with respect to a particular project (e.g., as identified 214 by PCE process 20), it may be appropriate to re-designate that resource as dedicated rather than non-dedicated (e.g., by utilizing PM application 44 to edit various project parameters). Similarly, if a particular dedicated resource is not being appropriately utilized with respect to a particular project (e.g., as identified 222 by PCE process 20), it may be appropriate to re-designate that resource as non-designated (and/or as designated to a lesser degree, such as “half-time” rather than “full time”).

It will be understood that PCE process 20 may determine 224, 226 a cost estimate for a project alone and/or in conjunction with another application or process. For example, PCE process 20 may provide relevant information to and/or receive relevant information from a PM application (e.g., PM application 44) in order to determine 224, 226 a particular cost estimate. It will further be understood that a determined 224, 226 cost estimate may be of varying accuracy with respect to actual costs of a project based upon, for example, varying levels of uncertainty associated with determining 220 time estimates for utilization of resources with respect to particular secondary data sources, and/or various other sources of uncertainty associated with identifying 214, 222 the utilization of various resources. Nevertheless, even approximate estimates of project costs may be useful to project managers and/or other individuals such as, for example, in situations where individuals are not directly billing increments of time to a project but instead are simply designated as dedicated (or non-dedicated), in total, with respect to a particular project.

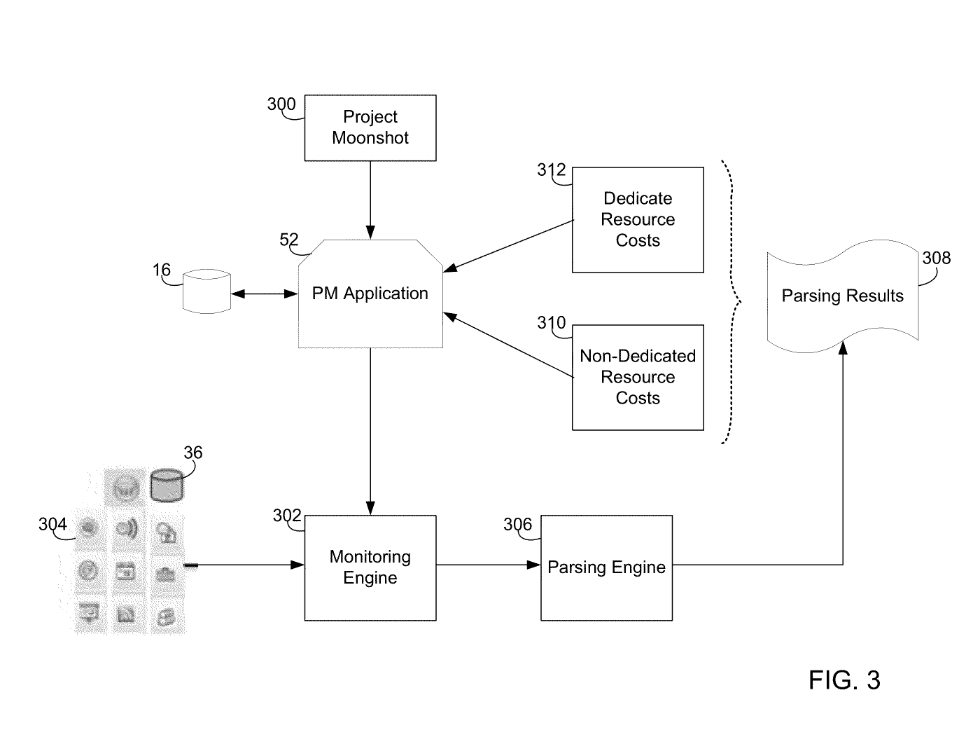

Referring now also to FIG. 3, for example, new project 300—i.e., “Project Moonshot”—may be created by a project administrator and various parameters relating to the project may be provided to a PM application (e.g., PM application 52, which may communicate, for example, with a storage device for financial and/or other information, such as storage device 16). For example, upon creating and/or editing Project Moonshot through PM application 52, an administrator may designate various resources as dedicated or non-dedicated and/or may indicate various project identifiers that may be associated with the project.

Monitoring engine 302, which may be associated, for example, with PCE process 20, may receive information relating to Project Moonshot from PM application 52 including, for example, various project identifiers associated with Project Moonshot. Monitoring engine 302 may accordingly identify 202 various secondary data sources by, for example, monitoring 210 various communication channels and/or analyzing 212 various communication items in order to identify 204 one or more associations of the received project identifiers with the various secondary data sources. For example, monitoring engine 302 may monitor 210 text chat channels 304 and/or may analyze 212 various communication items (e.g., emails or other communication items stored on storage device 36). Monitoring engine 302 may operate on one more devices and may be associated with PM process 20 in various ways.

Upon monitoring engine 302 having identified 202 various relevant secondary data sources (e.g., various emails, presentations, updates, documents, meeting transcripts, calendar events, and so on, which may contain and/or otherwise be associated with relevant project identifiers), parsing engine 304 may analyze 216 various information from the identified 202 data sources. For example, parsing engine 304 may analyze 218 various semantic aspects of information from the identified 202 data sources (e.g., the complexity of associated information) to identify 214, 222 the use of various resources on a project.

In certain embodiments, parsing engine 306 may determine various parsing results 308, which may, for example, include assessments relevant to dedicated resource costs 312 and/or non-dedicated resource costs 310. For example, through parsing engine 306, PCE process 20 may determine 224, 226 cost estimates for non-dedicated and dedicated resources based on analysis of various information from the identified 202 secondary data sources. Such information and/or costs (or cost estimates) may then, for example, be provided to PM application 52 in order to facilitate updating appropriate project cost estimates for Project Moonshot.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

1.-7. (canceled)

8. A computer program product residing on a non-transitory computer-readable storage medium having a plurality of instructions stored thereon, which, when executed by a processor, cause the processor to perform operations comprising:
identifying one or more project identifiers associated with a project;
identifying a secondary data source associated with the project, the identifying based upon, at least in part, identifying an association of the one or more of the project identifiers with the secondary data source;
identifying a use of a non-dedicated resource on the project based upon, at least in part, analyzing information from the secondary data source; and
determining a cost estimate associated with the project based upon, at least in part, the identified use of the non-dedicated resource on the project.

9. The computer program product of claim 8 wherein identifying the secondary data source is based upon, at least in part, one or more of monitoring a communication channel and analyzing a communication item.

10. The computer program product of claim 8 wherein the secondary data source includes a calendar event.

11. The computer program product of claim 8 wherein the secondary data source includes presentation material.

12. The computer program product of claim 8 wherein analyzing the information from the secondary data source includes determining a time estimate for resource utilization based upon, at least in part, a complexity of the information.

13. The computer program product of claim 8 wherein analyzing the information from the secondary data source includes analyzing semantic aspects of the information.

14. The computer program product of claim 8 wherein the operations further comprise:
identifying a use of a dedicated resource on the project based upon, at least in part, analyzing information from the secondary data source; and
determining an updated cost estimate associated with the project based upon, at least in part, comparing the identified use of the dedicated resource with a prior estimate of use of the dedicated resource.

15. A computer system comprising:
one or more processor devices; and
one or more memory architectures coupled with the one or more processor devices;
wherein the one or more processor devices are configured to:
identify one or more project identifiers associated with a project;
identify a secondary data source associated with the project, the identifying based upon, at least in part, identifying an association of the one or more of the project identifiers with the secondary data source;
identify a use of a non-dedicated resource on the project based upon, at least in part, analyzing information from the secondary data source; and
determine a cost estimate associated with the project based upon, at least in part, the identified use of the non-dedicated resource on the project.

16. The computer system of claim 15 wherein identifying the secondary data source is based upon, at least in part, one or more of monitoring a communication channel and analyzing a communication item.

17. The computer system of claim 15 wherein the secondary data source includes a calendar event.

18. The computer system of claim 15 wherein the secondary data source includes presentation material.

19. The computer system of claim 15 wherein analyzing the information from the secondary data source includes determining a time estimate for resource utilization based upon, at least in part, a complexity of the information.

20. The computer system of claim 15 wherein analyzing the information from the secondary data source includes analyzing semantic aspects of the information.

21. The computer system of claim 15 wherein the one or more processor devices are further configured to:
identify a use of a dedicated resource on the project based upon, at least in part, analyzing information from the secondary data source; and
determining an updated cost estimate associated with the project based upon, at least in part, comparing the identified use of the dedicated resource with a prior estimate of use of the dedicated resource.

22-25. (canceled)
